(19) United States
(12) Patent Application Publication
(10) Pub. No.: US 2026/0094805 A1
(43) Pub. Date: Apr. 2, 2026

(54) METHOD OF MANUFACTURING ELECTRODE FOR LITHIUM SECONDARY BATTERY

(71) Applicant: SK ON CO., LTD., Seoul (KR)

(72) Inventors: Young Gil CHOI, Daejeon (KR); Kwang Ho JEONG, Daejeon (KR); Young Ju CHOI, Daejeon (KR)

(21) Appl. No.: 19/346,564

(22) Filed: Oct. 1, 2025

(30) Foreign Application Priority Data
Oct. 2, 2024 (KR) 10-2024-0133885

(51) Int. Cl. H01M 4/04; H01M 4/62; H01M 10/052

(52) U.S. Cl. CPC H01M 4/0435; H01M 4/0471; H01M 4/622; H01M 10/052

(57) ABSTRACT

According to a method for manufacturing an electrode for a lithium secondary battery of the present disclosure, a solid-state electrode composition that includes an electrode active material and a binder including a rubber-based copolymer is prepared, a current collector is heated using a heating unit, and the current collector and electrode composition are roll-pressed using a rolling roller to form an electrode active material layer on at least one surface of the current collector. The rubber-based copolymer includes a butadiene-derived repeating unit, and the ratio of the molar amount of the butadiene-derived repeating unit to the total molar amount of repeating units in the rubber-based copolymer is 0.3 to 0.98.

### CROSS-REFERENCE TO RELATED APPLICATION

This application claims priority under 35 U.S.C. § 119 to Korean Patent Application No. 10-2024-0133885, filed on Oct. 2, 2024, the disclosure of which is incorporated herein by reference in its entirety.

### BACKGROUND OF THE INVENTION

### 1. Field of the Invention

The disclosure of the present application relates to a method for manufacturing an electrode for a lithium secondary battery.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric vehicles.

Examples of secondary batteries may include a lithium secondary battery, a nickel-cadmium battery, and a nickel-hydrogen battery. Among these, lithium secondary batteries are actively being researched and developed due to their high operating voltage, high energy density per unit weight, and advantages in charging speed and weight reduction.

Recently, as the application scope of lithium secondary batteries continues to expand, methods for manufacturing electrodes for lithium secondary batteries that have higher reliability and process stability are being developed. For example, during the electrode manufacturing process, the resistance, adhesion, and cycle life characteristics of the electrode may deteriorate depending on the temperature of the manufacturing equipment and the type and components of the electrode composition.

### SUMMARY OF THE INVENTION

According to an aspect of the present disclosure, a method for manufacturing an electrode for a lithium secondary battery with improved operating reliability, output characteristics, and cycle life characteristics may be provided.

According to exemplary embodiments, there is provided a method for manufacturing an electrode for a lithium secondary battery, including: preparing a solid-state electrode composition including an electrode active material and a rubber-based copolymer; heating a current collector using a heating unit; and roll-pressing the current collector and the electrode composition using a rolling roller to form an electrode active material layer on at least one surface of the current collector, wherein the rubber-based copolymer includes a butadiene-derived repeating unit; and wherein the ratio of the molar amount of the butadiene-derived repeating unit to the total molar amount of repeating units in the rubber-based copolymer is 0.3 to 0.98.

According to exemplary embodiments, the ratio of the molar amount of the butadiene-derived repeating unit to the total molar amount of repeating units in the rubber-based copolymer is 0.5 to 0.75.

According to exemplary embodiments, the rubber-based copolymer has a glass transition temperature of −95° C. to 40° C.

According to exemplary embodiments, the electrode active material layer is formed directly on at least one surface of the current collector.

According to exemplary embodiments, the rubber-based copolymer further includes a styrene-derived repeating unit.

According to exemplary embodiments, the rubber-based copolymer further includes at least one selected from the group consisting of an acrylonitrile-derived repeating unit and a farnesene-derived repeating unit.

According to exemplary embodiments, the rubber-based copolymer is in a liquid state at room temperature.

According to exemplary embodiments, the roll-pressing is performed after heating the current collector.

According to exemplary embodiments, the temperature of the rolling roller is 25° C. or lower.

According to exemplary embodiments, the shortest distance between the rolling roller and the heating unit is 5 cm to 50 cm.

According to exemplary embodiments, the heating unit includes at least one selected from the group consisting of an induction heating annealing (IHA) unit, an infrared (IR) heating unit, and a hot air heating unit.

According to exemplary embodiments, the electrode for a lithium secondary battery includes at least one of a cathode and an anode.

According to exemplary embodiments, there is provided a lithium secondary battery including the electrode manufactured according to the method, the electrode including an electrode active material and a rubber-based copolymer, wherein the rubber-based copolymer includes a butadiene-derived repeating unit, and the ratio of the molar amount of the butadiene-derived repeating unit to the total molar amount of repeating units in the rubber-based copolymer is 0.3 to 0.98.

According to an embodiment of the present disclosure, the fluidity of a rubber-based copolymer used as a binder for the electrode may be sufficiently increased. Accordingly, an electrode active material layer may be formed directly on at least one surface of a current collector without a separate adhesive layer. Consequently, the electrode resistance may be reduced, processability may be improved, and cycle life characteristics may be enhanced.

According to an embodiment of the present disclosure, an eco-friendly and cost-effective method for manufacturing an electrode for a lithium secondary battery may be provided.

According to an embodiment of the present disclosure, an electrode composition sheet may be stably attached to a current collector even with a rolling roller in a cooled state (e.g., 25° C. or lower). Consequently, contamination of the electrode, increase in resistance, and deterioration of cycle life characteristics due to a high-temperature rolling roller may be prevented.

According to an embodiment of the present disclosure, the structural stability of the electrode may be improved, while contamination and resistance of the electrode may be reduced, and cycle life characteristics may be enhanced.

The method for manufacturing an electrode for a lithium secondary battery of the present disclosure may be widely applied in green technology fields, such as electric vehicles, battery charging stations, as well as solar power generation, wind power generation, and the like, which use the batteries. The method for manufacturing an electrode for a lithium secondary battery of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic flowchart for describing a method for manufacturing an electrode for a lithium secondary battery according to exemplary embodiments;

FIG. 2 is a schematic view illustrating a manufacturing process of an electrode for a lithium secondary battery according to exemplary embodiments; and

FIGS. 3 and 4 are schematic plan and cross-sectional views, respectively, illustrating a lithium secondary battery according to exemplary embodiments.

### DETAILED DESCRIPTION OF THE INVENTION

Embodiments of the present disclosure provide a method for manufacturing an electrode for a lithium secondary battery (hereinafter, also abbreviated as “electrode”). In addition, a lithium secondary battery (hereinafter, abbreviated as “secondary battery”) including the electrode is provided.

Hereinafter, embodiments of the present disclosure will be described in detail with reference to the drawings. However, the embodiments are merely illustrative, and the present disclosure is not limited to the specific embodiments described as examples.

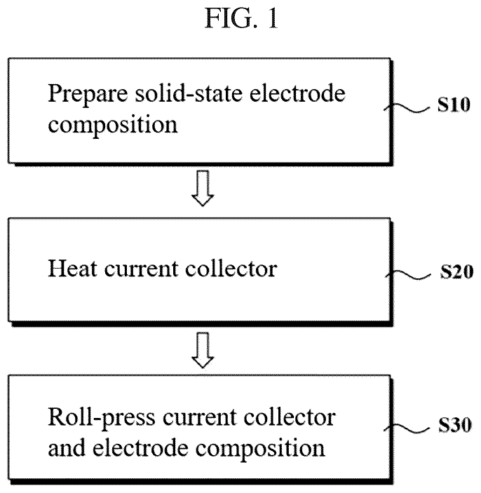

FIG. 1 is a schematic flowchart for describing a method for manufacturing an electrode for a lithium secondary battery according to exemplary embodiments.

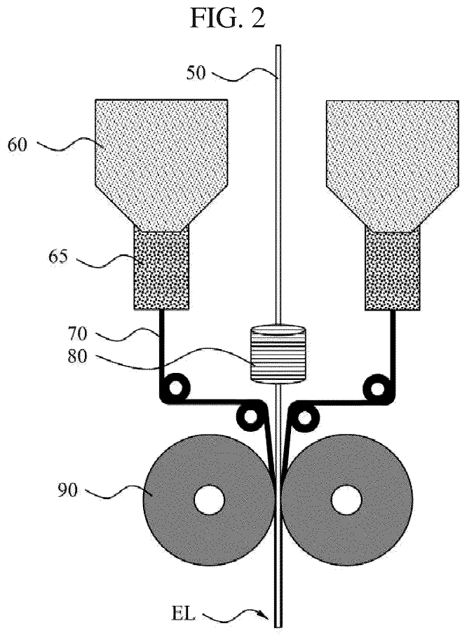

FIG. 2 is a schematic view illustrating a manufacturing process of an electrode for a lithium secondary battery according to exemplary embodiments.

Referring to FIGS. 1 and 2, a solid-state electrode composition may be prepared (e.g., step S10).

For example, the solid-state electrode composition may be eco-friendly because it does not contain a solvent, and since a separate dryer is not required during the electrode manufacturing process, the manufacturing cost of the electrode may be reduced.

In exemplary embodiments, the electrode composition may include an electrode active material and a rubber-based copolymer. The rubber-based copolymer may serve as a binder for the electrode.

In some embodiments, the electrode may include at least one of a cathode and an anode. For example, the electrode active material may be a cathode active material or an anode active material.

For example, the cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

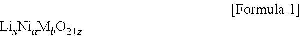

In Formula 1, x, a, b and z may satisfy 0.95≤x≤1.2, 0.6≤a≤0.99, 0.01≤b≤0.4, and −0.5≤z≤0.1. As described above, M may include Co, Mn and/or Al.

The chemical structure represented by Formula 1 indicates a bonding relationship between elements included in the layered structure or the crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element which contributes to the capacity/output activity of the cathode active material together with Co or Mn, such as Al.

For example, the cathode active material or the lithium-nickel metal oxide may include a layered structure or a crystal structure represented by Formula 1-1 below.

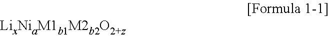

In Formula 1-1, M1 may include Co, Mn and/or Al. M2 may include the above-described auxiliary elements. In Formula 1-1, x, a, b1, b2 and z may satisfy 0.95≤x≤1.2, 0.6≤a≤0.99, 0.01≤b1+b2≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of lithium-nickel metal oxide particles, or may penetrate through the surface of the lithium-nickel metal oxide particles to be incorporated into the bonding structure represented by Formula 1 or Formula 1-1 above.

The cathode active material may include a nickel-cobalt-manganese (NCM)-based lithium oxide. In this case, an NCM-based lithium oxide having an increased content of nickel may be used.

Nickel (Ni) may be provided as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

The content of Ni (e.g., the molar fraction of nickel based on the total molar amount of nickel, cobalt and manganese) in the NCM-based lithium oxide may be 0.5 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a lithium (Li)-rich layered oxide (LLO)/over-lithiated oxide (OLO)-based active material, a manganese (Mn)-rich active material, or a cobalt (Co)-less active material, which have a chemical structure or a crystal structure represented by Formula 2 below.

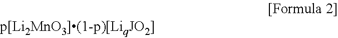

In Formula 2, p and q may satisfy 0<p<1, and 0.95≤q≤1.2, and J may include at least one element selected from the group consisting of Mn, Ni, Co, Fe, Cr, V, Cu, Zn, Ti, Al, Mg and B.

For example, the anode active material may include a material capable of adsorbing and desorbing lithium ions. For example, as the anode active material, carbon-based materials such as crystalline carbon, amorphous carbon, carbon composites, or carbon fibers, etc.; lithium metal; a lithium alloy; a silicon (Si)-containing material or a tin (Sn)-containing material may be used. These may be used singly or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In one embodiment, a lithium metal-containing layer deposited or coated on the anode current collector may be used as the anode active material layer. In one embodiment, a lithium thin film layer may be used as the anode active material layer.

Elements included in the lithium alloy may include aluminum, zinc, bismuth, cadmium, antimony, silicon, lead, tin, gallium or indium, etc. These elements may be used alone or in combination of two or more thereof.

The silicon-containing material may provide further increased capacity characteristics. The silicon-containing material may include Si, SiOₓ (0<x<2), metal-doped SiOₓ (0<x<2), silicon-carbon composites, etc.

The metal may include lithium and/or magnesium, and the metal-doped SiOₓ (0<x<2) may include a metal silicate.

In some embodiments, the electrode composition may further include a conductive material.

For example, the conductive material may be added to enhance conductivity of the electrode and/or mobility of lithium ions or electrons. For example, the conductive material may include carbon-based conductive materials such as conductive carbon, graphite, carbon black, acetylene black, Ketjen black, graphene, carbon nanotubes (CNTs), vapor-grown carbon fibers (VGCFs) or carbon fibers, and/or metal-based conductive materials including perovskite materials, such as tin, tin oxide, titanium oxide, LaSrCoO₃, and LaSrMnO₃. These may be used alone or in combination of two or more thereof.

In exemplary embodiments, the rubber-based copolymer may include a butadiene-derived repeating unit.

The term “A-derived repeating unit” as used herein may refer to a repeating unit derived from a monomer A among the repeating units included in the copolymer. For example, the butadiene-derived repeating unit may refer to a repeating unit derived from a 1,3-butadiene monomer and included as a constituent of the rubber-based copolymer.

For example, a homopolymer of butadiene may have a glass transition temperature (Tg) of about −100° C. Accordingly, the fluidity of the rubber-based copolymer may increase due to the butadiene-derived repeating unit.

In exemplary embodiments, the ratio of the molar amount of the butadiene-derived repeating unit to the total molar amount of repeating units in the rubber-based copolymer may be 0.3 to 0.98, and in some embodiments, 0.5 to 0.75. Within this range, the fluidity of the rubber-based copolymer provided as a binder for the electrode may be sufficiently increased. Accordingly, an electrode active material layer may be directly formed on at least one surface of a current collector without a separate adhesive layer, such as a primer layer, which acts as a defect in the electrode and increases resistance. As a result, the resistance of the electrode may be reduced, the processability may be improved, and the cycle life characteristics may be enhanced.

In some embodiments, the rubber-based copolymer may be in a liquid state at room temperature (25° C.). Accordingly, the adhesion between the current collector and the electrode active material layer may be further enhanced.

If the ratio of the molar amount of the butadiene-derived repeating unit to the total molar amount of repeating units in the rubber-based copolymer is less than 0.3, the adhesion between the current collector and the electrode active material layer may be reduced, and the resistance may increase.

If the ratio of the molar amount of the butadiene-derived repeating unit to the total molar amount of repeating units in the rubber-based copolymer exceeds 0.98, the resistance of the electrode may increase and the cycle life characteristics may deteriorate.

In some embodiments, the rubber-based copolymer may further include a styrene-derived repeating unit.

For example, a homopolymer of styrene may have a glass transition temperature of about 100° C. Accordingly, the fluidity of the rubber-based copolymer may be controlled by adjusting the molar ratio between the butadiene-derived repeating unit and the styrene-derived repeating unit.

In some embodiments, the rubber-based copolymer may have a glass transition temperature of −95° C. to 40° C. The glass transition temperature of the rubber-based copolymer may be controlled by the molar ratio between the butadiene-derived repeating unit and the styrene-derived repeating unit. Within this glass transition temperature range, the fluidity of the rubber-based copolymer may be improved and the resistance may be reduced. Accordingly, the rubber-based copolymer may remain in a liquid state at room temperature, and the output characteristics of the electrode may be improved.

In some embodiments, the rubber-based copolymer may have a weight average molecular weight (Mw) of 3,000 to 100,000. Within this range, the fluidity of the rubber-based copolymer serving as a binder for the electrode may increase, thereby improving the adhesion between the electrode active material layer and the current collector.

In some embodiments, the rubber-based copolymer may further include an auxiliary compound-derived repeating unit. For example, the rubber-based copolymer may further include a conjugated diene compound-derived repeating unit, an unsaturated carboxylic acid-derived repeating unit, or the like.

For example, the conjugated diene compounds may include isoprene, 2,3-dimethyl-1,3-butadiene, 1,3-pentadiene, piperylene, or the like.

For example, the unsaturated carboxylic acid may include at least one selected from the group consisting of an unsaturated monocarboxylic acid and a derivative thereof, an unsaturated dicarboxylic acid and an acid anhydride or a derivative thereof.

For example, the unsaturated monocarboxylic acid may include acrylic acid, methacrylic acid, crotonic acid, or the like.

For example, the derivative of the unsaturated monocarboxylic acid may include 2-ethylacrylic acid, isocrotonic acid, α-acetoxyacrylic acid, β-trans-aryloxyacrylic acid, α-chloro-β-E-methoxyacrylic acid, β-diamino acrylic acid, or the like.

For example, the unsaturated dicarboxylic acid may include maleic acid, fumaric acid, itaconic acid, maleic anhydride, acrylic anhydride, methyl maleic anhydride, dimethyl maleic anhydride, or the like.

For example, the derivative of the unsaturated dicarboxylic acid may include methylmaleic acid, dimethylmaleic acid, phenylmaleic acid, chloromaleic acid, dichloromaleic acid, fluoromaleic acid, methylallyl maleate, diphenyl maleate, nonyl maleate, decyl maleate, dodecyl maleate, octadecyl maleate, fluoroalkyl maleate, or the like.

In some embodiments, the rubber-based copolymer may further include at least one selected from the group consisting of an acrylonitrile-derived repeating unit and a farnesene-derived repeating unit. Accordingly, detailed physical properties of the rubber-based copolymer, such as flowability, conductivity, and storability, may be controlled according to technical purposes.

In some embodiments, the auxiliary compound may include α-methylstyrene, β-methylstyrene, p-t-butylstyrene, chlorostyrene, acrylonitrile, methacrylonitrile, acrylamide, N-methylolacrylamide, N-butoxymethylacrylamide, methacrylamide, N-methylolmethacrylamide, N-butoxymethylmethacrylamide, glycidyl acrylate, glycidyl methacrylate, allyl glycidyl ether, sodium styrene sulfonate, acrylamide methylpropanesulfonic acid, dimethylaminoethyl methacrylate, diethylaminoethyl methacrylate, methoxypolyethylene glycol monomethacrylate, (meth)acrylate-2,2,2-trifluoroethyl, (meth)acrylate-β-(perfluorooctyl)ethyl, (meth)acrylate-2,2,3,3-tetrafluoropropyl, (meth)acrylate-2,2,3,4,4,4-hexafluorobutyl, (meth)acrylate-1H,1H,9H-perfluoro-1-nonyl, (meth)acrylate-1H,1H,11H-perfluoroundecyl, (meth)acrylate perfluorooctyl, (meth)acrylate-3-[4-[1-trifluoromethyl-2,2-bis[bis(trifluoromethyl)fluoromethyl]ethynyloxy]benzyloxy]-2-hydroxypropyl, a fluorine-containing methacrylic monomer, monooctyl maleate, monobutyl maleate, monooctyl itaconate, etc. These may be used alone or in combination of two or more thereof.

In one embodiment, the rubber-based copolymer may include a styrene-butadiene rubber (SBR) copolymer.

Referring to FIG. 2, in some embodiments, an electrode composition raw material including an electrode active material and a rubber-based copolymer may be fed into an inlet 60 of an electrode manufacturing device.

The electrode composition raw material may be transferred from the inlet 60 to a mixer 65 and mixed to prepare a solid-state electrode composition.

The electrode composition may be extruded from the mixer 65 in the form of an electrode composition sheet 70.

In exemplary embodiments, a current collector 50 may be heated by a heating unit 80 (e.g., step S20).

In some embodiments, preheating the current collector 50 prior to roll-pressing may improve the adhesion between the current collector 50 and the electrode composition sheet 70, thereby suppressing contamination and an increase in resistance during a subsequent roll-pressing process.

The current collector 50 may include, for example, a cathode current collector or an anode current collector.

For example, the cathode current collector may include stainless steel, nickel, aluminum, titanium, or an alloy thereof. The cathode current collector may also include aluminum or stainless steel having a surface treated with carbon, nickel, titanium, or silver. For example, the cathode current collector may have a thickness of 10 μm to 50 μm.

For example, the anode current collector may include a copper foil, a nickel foil, a stainless steel foil, a titanium foil, a nickel foam, a copper foam, a polymer substrate coated with a conductive metal and the like. These may be used alone or in combination of two or more thereof. For example, the anode current collector may have a thickness of 10 μm to 50 μm.

In some embodiments, the heating unit 80 may include at least one selected from the group consisting of an induction heating annealing (IHA) unit, an infrared (IR) heating unit, and a hot air heating unit.

For example, the IHA unit may include an induction heating unit utilizing electromagnetic induction. Accordingly, the stability and efficiency of heating the current collector 50 may be improved.

For example, the current collector 50 may be heated by passing through the heating unit 80.

In some embodiments, the heating temperature of the heating unit 80 may be 30° C. to 400° C. Within this range, the current collector 50 and the electrode composition sheet 70 may be stably attached, while preventing contamination of the electrode.

In exemplary embodiments, the current collector 50 and the electrode composition (e.g., the electrode composition sheet 70) may be roll-pressed by a rolling roller 90 to form an electrode (EL) in which an electrode active material layer is disposed on at least one surface of the current collector 50 (e.g., step S30).

The roll-pressing may be performed after the current collector 50 is preheated by the heating unit 80. By preheating the current collector 50 prior to roll-pressing, the electrode composition sheet 70 may be stably attached to the current collector 50 even with the rolling roller 90 in a cooled state (e.g., 25° C. or lower). Accordingly, contamination of the electrode, energy waste, increase in resistance, and deterioration of cycle life characteristics due to a high-temperature rolling roller may be prevented.

In some embodiments, the temperature of the rolling roller 90 may be 25° C. or lower, and in one embodiment, 15° C. to 25° C. Accordingly, the temperature of the rolling roller 90 may be maintained at room temperature or lower, thereby reducing the electrode manufacturing cost, electrode resistance and contamination, and improving the cycle life characteristics of the electrode.

As shown in FIG. 2, the rolling roller 90 may include a pair of opposing rolling roller units. For example, the roll-pressing may be performed at the point (e.g., the rolling point) where the pair of rolling roller units are closest to each other.

In some embodiments, the shortest distance between the rolling roller and the heating unit 80 may be 5 cm to 50 cm, and in one embodiment, 20 cm to 40 cm.

As described above, an adhesive layer, such as a primer layer, may not be disposed between the current collector 50 and the electrode composition sheet 70. For example, the electrode composition sheet 70 may be directly disposed on at least one surface of the current collector 50. Accordingly, the resistance of the electrode may be reduced and the manufacturing process may be simplified

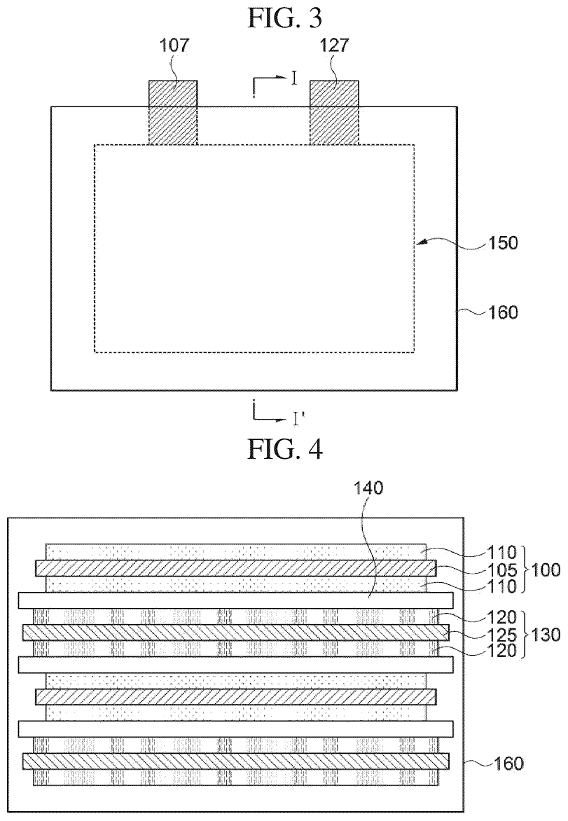

FIGS. 3 and 4 are schematic plan and cross-sectional views, respectively, illustrating a lithium secondary battery according to exemplary embodiments. For example, FIG. 4 is a cross-sectional view taken along line I-I′ of FIG. 3 in the thickness direction of the battery.

The lithium secondary battery according to some embodiments may include the electrode manufactured according to the above-described manufacturing method, which includes an electrode active material and a rubber-based copolymer, wherein the rubber-based copolymer includes a butadiene-derived repeating unit, and the ratio of the molar amount of the butadiene-derived repeating unit to the total molar amount of repeating units in the rubber-based copolymer is 0.3 to 0.98. For example, the electrode may include an anode 130 or a cathode 100 disposed opposite to the anode 130.

The cathode 100 may include a cathode current collector 105, and a cathode active material layer 110 formed on at least one surface of the cathode current collector 105 and including the above-described cathode active material.

The anode 130 may include an anode current collector 125 and an anode active material layer 120 formed on at least one surface of the anode current collector 125 and including the above-described anode active material.

In exemplary embodiments, a separation membrane 140 may be interposed between the cathode 100 and the anode 130. The separation membrane 140 may be configured to prevent an electrical short-circuit between the cathode 100 and the anode 130, and to allow the flow of ions. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be coated on the polymer film or dispersed within the polymer film to improve heat resistance.

The separation membrane 140 may have a single-layer or multi-layer structure including the above-described polymer film and/or non-woven fabric.

According to exemplary embodiments, an electrode cell may be defined by the cathode 100, the anode 130 and the separation membrane 140, and a plurality of electrode cells may be stacked to form, for example, a jelly roll type electrode assembly 150. For example, the electrode assembly 150 may be formed by winding, stacking, z-folding, or stack-folding the separation membrane 140.

The electrode assembly 150 may be accommodated in a case 160 together with the electrolyte to define a lithium secondary battery. According to exemplary embodiments, a non-aqueous electrolyte may be used as the electrolyte.

The non-aqueous electrolyte may include a lithium salt of an electrolyte and an organic solvent. For example, the lithium salt may be represented by Li⁺X⁻; and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻; (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato) phosphate, lithium difluorophosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 3 and 4, electrode tabs (cathode tabs and anode tabs) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Example 1

### Fabrication of Electrode

30 mol % of 1,3-butadiene and 70 mol % of styrene were polymerized to prepare a first styrene-butadiene rubber (SBR) copolymer, in which the ratio of the molar amount of butadiene-derived repeating unit to the total molar amount of repeating units in the copolymer was 0.3, and the glass transition temperature was 40° C.

A solid-state electrode composition raw material including artificial graphite as an electrode active material, conductive carbon as a conductive material, and the first SBR copolymer as a binder in a weight ratio of 96:1:3 was introduced into an inlet of an electrode manufacturing device.

The electrode composition raw material was transferred from the inlet to a mixer and mixed to prepare a solid-state electrode composition.

The electrode composition was extruded from the mixer in the form of an electrode composition sheet.

After passing a current collector (copper foil) through an induction heating (IHA) unit heated to 60.2° C., the electrode composition sheet and the current collector were roll-pressed through a rolling roller heated to 25° C. to fabricate an electrode including electrode active material layers disposed on both surfaces of the current collector.

The shortest distance between the rolling roller and the IHA unit was 30 cm.

### Manufacture of a Lithium Half-Cell

A lithium half-cell was manufactured using the electrode and lithium metal as the counter electrode.

Specifically, a separation membrane (polyethylene, thickness 20 μm) was interposed between the electrode and lithium metal (thickness 1 mm) to form a lithium coin half-cell in accordance with the CR2016 standard (diameter 20 mm, thickness 1.6 mm).

The assembly of the lithium metal/separation membrane/electrode was placed in a coin cell plate. After injection of the electrolyte, a cap was placed on the plate and the cell was clamped. A solution, prepared by dissolving 1 M LiPF₆ in a mixed solvent of EC/EMC (3:7; volume ratio), and further adding 2.0 vol % of fluoroethylene carbonate (FEC) based on the total volume of the electrolyte, was used as the electrolyte. After clamping, the cells were allowed to stand for impregnation for 3 to 24 hours, followed by three charge/discharge cycles at 0.1 C (charging conditions: CC/CV 0.1 C 0.01 V 0.01 C cut-off; discharging conditions: CC 0.1 C 1.5 V cut-off).

### Example 2

50 mol % of 1,3-butadiene and 50 mol % of styrene were polymerized to prepare a second SBR copolymer, in which the ratio of the molar amount of butadiene-derived repeating unit to the total molar amount of repeating units in the copolymer was 0.5, and the glass transition temperature was 0° C.

An electrode and a lithium half-cell were manufactured in the same manner as in Example 1, except that an equivalent amount of the second SBR copolymer was used as a binder instead of the first SBR copolymer.

### Example 3

55 mol % of 1,3-butadiene and 45 mol % of styrene were polymerized to prepare a third SBR copolymer, in which the ratio of the molar amount of butadiene-derived repeating unit to the total molar amount of repeating units in the copolymer was 0.55, and the glass transition temperature was −10° C.

An electrode and a lithium half-cell were manufactured in the same manner as in Example 1, except that an equivalent amount of the third SBR copolymer was used as a binder instead of the first SBR copolymer.

### Example 4

75 mol % of 1,3-butadiene and 25 mol % of styrene were polymerized to prepare a fourth SBR copolymer, in which the ratio of the molar amount of butadiene-derived repeating unit to the total molar amount of repeating units in the copolymer was 0.75, and the glass transition temperature was −50° C.

An electrode and a lithium half-cell were manufactured in the same manner as in Example 1, except that the electrode composition raw material included artificial graphite, conductive carbon, polytetrafluoroethylene (PTFE), and the fourth SBR copolymer in a weight ratio of 96:1:1:2.

### Example 5

An electrode and a lithium half-cell were manufactured in the same manner as in Example 1, except that an equivalent amount of the fourth SBR copolymer was used as a binder instead of the first SBR copolymer.

### Example 6

97.5 mol % of 1,3-butadiene and 2.5 mol % of styrene were polymerized to prepare a fifth SBR copolymer, in which the ratio of the molar amount of butadiene-derived repeating unit to the total molar amount of repeating units in the copolymer was 0.975, and the glass transition temperature was −95° C.

An electrode and a lithium half-cell were manufactured in the same manner as in Example 1, except that an equivalent amount of the fifth SBR copolymer was used as a binder instead of the first SBR copolymer.

### Examples 7 to 12

Electrodes and lithium half-cells were manufactured in the same manner as in Example 1, except that the shortest distance between the rolling roller and the IHA unit was adjusted as shown in Table 1.

### Comparative Example 1

A solid-state electrode composition raw material including artificial graphite as an electrode active material, conductive carbon as a conductive material, and PTFE as a binder in a weight ratio of 96:1:3 was introduced into an inlet of an electrode manufacturing device.

The electrode composition raw material was transferred from the inlet to a mixer and mixed to prepare a solid-state electrode composition.

The electrode composition was extruded from the mixer in the form of an electrode composition sheet.

After passing a current collector through an induction heating (IHA) unit heated to 60.2° C., the electrode composition sheet and the current collector were roll-pressed through a rolling roller heated to 25° C. to fabricate an electrode including electrode active material layers disposed on both surfaces of the current collector.

The shortest distance between the rolling roller and the IHA unit was 30 cm.

A primer layer including conductive carbon, carboxymethyl cellulose (CMC), SBR, and polyvinylpyrrolidone (PVP) in a weight ratio of 48:4:24:24 was formed on the current collector (copper foil).

After passing the laminate of the current collector and the primer layer through an induction heating (IHA) unit heated to 41.4° C., the electrode composition sheet, the primer layer and the current collector were roll-pressed through a rolling roller to fabricate an electrode including primer layers disposed on both surfaces of the current collector and electrode active material layers disposed on the primer layers.

The shortest distance between the rolling roller and the IHA unit was 30 cm.

A lithium half-cell including the electrode was manufactured in the same manner as in Example 1.

### Comparative Example 2

An electrode and a lithium half-cell were manufactured in the same manner as in Comparative Example 1, except that the electrode composition raw material included artificial graphite, conductive carbon, PTFE, and polyvinylidene fluoride (PVDF) in a weight ratio of 96:1:2:1.

### Comparative Example 3

25 mol % of 1,3-butadiene and 75 mol % of styrene were polymerized to prepare a sixth SBR copolymer, in which the ratio of the molar amount of butadiene-derived repeating unit to the total molar amount of repeating units in the copolymer was 0.25, and the glass transition temperature was 50° C.

An electrode and a lithium half-cell were manufactured in the same manner as Comparative Example 1, except that the electrode composition raw material included artificial graphite, conductive carbon, and the sixth SBR copolymer in a weight ratio of 96:1:3.

### Comparative Example 4

An electrode and a lithium half-cell were manufactured in the same manner as in Example 1, except that the electrode composition raw material included artificial graphite, conductive carbon, and the sixth SBR copolymer in a weight ratio of 96:1:3.

### Comparative Example 5

A butadiene copolymer was prepared by polymerizing 100 mol % 1,3-butadiene.

An electrode and a lithium half-cell were manufactured in the same manner as in Example 1, except that the electrode composition raw material included artificial graphite, conductive carbon and the butadiene copolymer in a weight ratio of 96:1:3.

### Experimental Example

### (1) Measurement of Adhesion

3M Magic Tape was attached to the electrodes of the examples and comparative examples, and pressure was applied to remove air bubbles. The adhesion between the electrode active material layer and the current collector was measured using an IMADA DS2-500N.

### (2) Measurement of Bulk Resistance and Interfacial Resistance

The electrodes of the examples and comparative examples were cut into 10 cm×10 cm samples. These samples were placed in a HIOKI RM2610 to measure bulk resistance and interfacial resistance.

### (3) Measurement of Direct Current Internal Resistance (DCIR)

The lithium half-cells of the examples and comparative examples were discharged to 50% state of charge (SOC) relative to the initial discharge capacity at room temperature (25° C.), rested for 1 hour, and then discharged at 1 C for 10 seconds. The DCIR was measured according to the following measurement equation:

DCIR=(V0−V1)/I [Measurement Equation]

In the measurement equation, V0 is the voltage of a lithium half-cell discharged to 50% SOC relative to the initial discharge capacity at room temperature (25° C.) and rested for 1 hour, V1 is the voltage of the lithium half-cell discharged at 1 C for 10 seconds, and I is the current value at 1 C.

### (4) Evaluation of Capacity Retention (500 Cycles)

The lithium half-cells of the examples and comparative examples were charged (CC/CV, 0.1 C, 0.01 V, 0.01 C cut-off) and discharged (CC, 0.1 C, 1.5 V cut-off) 500 cycles each at room temperature (25° C.). The capacity retention was evaluated by dividing the discharge capacity at the 500th cycle by the discharge capacity at the first cycle and multiplying the result by 100.

The measurement and evaluation results are shown in Table 2.

The ratio of the molar amount of butadiene-derived repeating unit to the total molar amount of repeating units in the SBR copolymers of the above-described examples and comparative examples, the glass transition temperature of the SBR copolymer, the presence or absence of a primer layer, and the shortest distance between the rolling roller and the IHA unit (“shortest distance” in Table 1) are shown in Table 1.

In Table 1, cases where a primer layer was formed are indicated as “◯,” and cases where a primer layer was not formed are indicated as “x”

TABLE 1

| | | Glass | | |
|---|---|---|---|---|
| | Molar ratio of | transition | Presence or | Shortest |
| | butadiene-derived | temperature | absence of | distance |
| | repeating unit | (° C.) | primer layer | (cm) |
| Example 1 | 0.3 | 40 | x | 30 |
| Example 2 | 0.5 | 0 | x | 30 |
| Example 3 | 0.55 | −10 | x | 30 |
| Example 4 | 0.75 | −50 | x | 30 |
| Example 5 | 0.75 | −50 | x | 30 |
| Example 6 | 0.975 | −95 | x | 30 |
| Example 7 | 0.3 | 40 | x | 5 |
| Example 8 | 0.3 | 40 | x | 20 |
| Example 9 | 0.3 | 40 | x | 40 |
| Example 10 | 0.3 | 40 | x | 50 |
| Example 11 | 0.3 | 40 | x | 3 |
| Example 12 | 0.3 | 40 | x | 55 |
| Comparative | — | — | ∘ | 30 |
| Example 1 | | | | |
| Comparative | — | — | ∘ | 30 |
| Example 2 | | | | |
| Comparative | 0.25 | 50 | ∘ | 30 |
| Example 3 | | | | |
| Comparative | 0.25 | 50 | x | 30 |
| Example 4 | | | | |
| Comparative | 1.0 | −100 | x | 30 |
| Example 5 | | | | |

TABLE 2

| | Adhesion | Bulk | Interfacial | | Capacity |
|---|---|---|---|---|---|
| | (N/18 | resistance | resistance | DCIR | retention (%, |
| | mm) | (mΩcm) | (mΩcm²) | (mΩ) | 500 cycles) |
| Example 1 | 0.39 | 57.7 | 35.5 | 0.999 | 92.8 |
| Example 2 | 0.47 | 55.1 | 30.9 | 0.935 | 93.2 |
| Example 3 | 0.58 | 42.6 | 25.4 | 0.920 | 94.4 |
| Example 4 | 1.09 | 49.6 | 26.3 | 0.902 | 95.1 |
| Example 5 | 1.36 | 38.2 | 18.8 | 0.885 | 97.0 |
| Example 6 | 1.39 | 40.9 | 22.1 | 0.913 | 95.0 |
| Example 7 | 0.46 | 56.5 | 34.5 | 0.967 | 91.5 |
| Example 8 | 0.43 | 57.1 | 35.1 | 0.970 | 92.6 |
| Example 9 | 0.41 | 57.6 | 35.3 | 1.001 | 93.6 |
| Example 10 | 0.37 | 57.9 | 36.2 | 1.005 | 92.5 |
| Example 11 | 0.34 | 58.8 | 36.5 | 1.008 | 91.6 |
| Example 12 | 0.61 | 55.5 | 37.1 | 0.934 | 94.2 |
| Comparative | 0.21 | 65.8 | 52.6 | 1.263 | 88.5 |
| Example 1 | | | | | |
| Comparative | 0.23 | 60.3 | 48.9 | 1.111 | 90.6 |
| Example 2 | | | | | |
| Comparative | 0.45 | 55.2 | 47.8 | 1.053 | 90.7 |
| Example 3 | | | | | |
| Comparative | 0.30 | 54.8 | 38.1 | 1.102 | 90.9 |
| Example 4 | | | | | |
| Comparative | 1.28 | 56.9 | 23.7 | 1.018 | 90.0 |
| Example 5 | | | | | |

Referring to Tables 1 and 2, in the examples using a rubber-based copolymer as a binder, where the molar ratio of the butadiene-derived repeating unit to the total molar amount of repeating units in the copolymer was 0.3 to 0.98, adhesion and capacity retention were generally improved, and resistance was reduced compared to the comparative examples.

In the examples without forming an adhesive layer such as a primer layer, adhesion was improved through the rubber-based copolymer, resulting in adhesion that was maintained or improved compared to Comparative Examples 1 to 3, which included a primer layer.

In Example 11, where the shortest distance between the rolling roller and the heating unit was less than 5 cm, the capacity retention was relatively reduced compared to Example 1, which otherwise had the same conditions.

In Example 12, where the shortest distance between the rolling roller and the heating unit exceeded 50 cm, adhesion was relatively reduced and resistance increased compared to Example 1 under the same conditions.

### DESCRIPTION OF REFERENCE NUMERALS

50: Current collector
60: Inlet
65: Mixer
70: Electrode composition sheet
80: Heating unit
90: Rolling roller
EL: Electrode
100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A method for manufacturing an electrode for a lithium secondary battery, comprising:
preparing a solid-state electrode composition comprising an electrode active material and a rubber-based copolymer,
heating a current collector using a heating unit; and
roll-pressing the current collector and the electrode composition using a rolling roller to form an electrode active material layer on at least one surface of the current collector,
wherein the rubber-based copolymer comprises a butadiene-derived repeating unit; and
wherein the ratio of the molar amount of the butadiene-derived repeating unit to the total molar amount of repeating units in the rubber-based copolymer is 0.3 to 0.98.

2. The method for manufacturing an electrode for a lithium secondary battery according to claim 1, wherein the ratio of the molar amount of the butadiene-derived repeating unit to the total molar amount of repeating units in the rubber-based copolymer is 0.5 to 0.75.

3. The method for manufacturing an electrode for a lithium secondary battery according to claim 1, wherein the rubber-based copolymer has a glass transition temperature of −95° C. to 40° C.

4. The method for manufacturing an electrode for a lithium secondary battery according to claim 1, wherein the electrode active material layer is formed directly on at least one surface of the current collector.

5. The method for manufacturing an electrode for a lithium secondary battery according to claim 1, wherein the rubber-based copolymer further comprises a styrene-derived repeating unit.

6. The method for manufacturing an electrode for a lithium secondary battery according to claim 1, wherein the rubber-based copolymer further comprises at least one selected from the group consisting of an acrylonitrile-derived repeating unit and a farnesene-derived repeating unit.

7. The method for manufacturing an electrode for a lithium secondary battery according to claim 1, wherein the rubber-based copolymer is in a liquid state at room temperature.

8. The method for manufacturing an electrode for a lithium secondary battery according to claim 1, wherein the roll-pressing is performed after heating the current collector.

9. The method for manufacturing an electrode for a lithium secondary battery according to claim 1, wherein the temperature of the rolling roller is 25° C. or lower.

10. The method for manufacturing an electrode for a lithium secondary battery according to claim 1, wherein the shortest distance between the rolling roller and the heating unit is 5 cm to 50 cm.

11. The method for manufacturing an electrode for a lithium secondary battery according to claim 1, wherein the heating unit comprises at least one selected from the group consisting of an induction heating annealing (IHA) unit, an infrared (IR) heating unit, and a hot air heating unit.

12. The method for manufacturing an electrode for a lithium secondary battery according to claim 1, wherein the electrode for a lithium secondary battery comprises at least one of a cathode and an anode.

13. A lithium secondary battery comprising the electrode manufactured according to the method of claim 1,
the electrode comprising an electrode active material and a rubber-based copolymer,
wherein the rubber-based copolymer comprises a butadiene-derived repeating unit, and the ratio of the molar amount of the butadiene-derived repeating unit to the total molar amount of repeating units in the rubber-based copolymer is 0.3 to 0.98.
